(19) United States
(12) Patent Application Publication
(10) Pub. No.: US 2016/0225410 A1
(43) Pub. Date: Aug. 4, 2016

(54) ACTION CAMERA CONTENT MANAGEMENT SYSTEM

(71) Applicant: Garmin Switzerland GmbH, Schaffhausen (CH)

(72) Inventors: Wai C. Lee, Overland Park, KS (US); Eric W. Heling, Overland Park, KS (US); Randall Canha, Lee's Summit, MO (US); Jeffrey B. Wigh, Olathe, KS (US); Nicolas S. Kral, Lawrence, KS (US)

(21) Appl. No.: 14/613,148

(22) Filed: Feb. 3, 2015

(51) Int. Cl. G11B 27/10

(52) U.S. Cl. CPC G11B 27/10

(57) ABSTRACT

Embodiments are disclosed to create a highlight video clip of a first physical event and a second physical event from one or more video clips based on a sensor parameter value generated by a sensor. Upon a physical event occurring, one or more associated sensor parameter values may exceed one or more threshold sensor parameter values or match a stored motion signature associated with a type of motion. Physical events may be recorded from multiple vantage points. A processor of a device or system may generate a highlight video clip by selecting a first video time window and a second video time window from the one or more video clips such that the first video time window begins before and ends after a first event time and the second video time window begins before and ends after a second event time.

### BACKGROUND

Often, people engaging in different types of activities may wish to capture these activities on video for personal or commercial use. The process of capturing these videos may involve mounting video equipment on the person participating in the activity, or the process may include one or more other persons operating multiple cameras to provide multiple vantage points of the recorded activities.

However, capturing video footage in this way generally requires one or more cameras to continuously capture video footage, which then must be painstakingly reviewed to determine the most interesting or favorable video clips to use in a highlight video compilation. Furthermore, once these video clips of interest are identified, a user then needs to manually select each video. As a result, techniques to automatically create video highlight reels would be particularly useful but also present several challenges.

### SUMMARY

Embodiments of the present technology relate generally to systems and devices operable to create videos and, more particularly, to the automatic creation of highlight video compilation clips using sensor parameter values generated by a sensor to identify physical events of interest and video clips thereof to be included in a highlight video clip. An embodiment of a system and a device configured to generate a highlight video clip broadly comprises a memory unit and a processor. The memory unit is configured to store one or more video clips, the one or more video clips, in combination, including a first data tag and a second data tag associated with a first physical event occurring in the one or more video clips and a second physical event occurring in the one or more video clips, respectively. In embodiments, the first physical event may have resulted in a first sensor parameter value exceeding a threshold sensor parameter value and the second physical event having resulted in a second sensor parameter value exceeding the threshold sensor parameter value. The memory unit may be further configured to store a motion signature and the processor may be further configured to compare a plurality of first sensor parameter values to the stored motion signature to determine at least one of the first event time and the second event time. The processor is configured to determine a first event time and a second event time based on a sensor parameter values generated by a sensor and generate a highlight video clip of the first physical event and the second physical event by selecting a first video time window and a second video time window from the one or more video clips such that the first video time window begins before and ends after the first event time and the second video time window begins before and ends after the second event time.

In embodiments, the second physical event may occur shortly after the first physical event and the second video time window from the one or more video clips begins immediately after the first video time window ends such that the highlight video clip includes the first physical event and the second physical event without interruption.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present technology will be apparent from the following detailed description of the embodiments and the accompanying drawing figures.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof. Further, whenever possible, the following description refers to the reference numerals included in the following figures, in which features depicted in multiple figures are designated with consistent reference numerals.

FIG. 1 is a block diagram of an exemplary highlight video recording system 100 in accordance with an embodiment of the present disclosure;

FIG. 2 is a block diagram of an exemplary highlight video compilation system 200 from a single camera according to an embodiment;

FIG. 3A is a schematic illustration example of a user interface screen 300 used to edit and view highlight videos, according to an embodiment;

FIG. 3B is a schematic illustration example of a user interface screen 350 used to modify settings, according to an embodiment;

FIG. 4A is a schematic illustration example of a highlight video recording system 400 implementing camera tracking, according to an embodiment;

FIG. 4B is a schematic illustration example of a highlight video recording system 450 implementing multiple cameras having dedicated sensor inputs, according to an embodiment;

FIG. 5 is a schematic illustration example of a highlight video recording system 500 implementing multiple camera locations to capture highlight videos from multiple vantage points, according to an embodiment;

FIG. 6 is a block diagram of an exemplary highlight video compilation system 600 using the recorded video clips from each of cameras 504.1-504.N, according to an embodiment; and

FIG. 7 illustrates a method flow 700, according to an embodiment.

### DETAILED DESCRIPTION

The following text sets forth a detailed description of numerous different embodiments. However, it should be understood that the detailed description is to be construed as exemplary only and does not describe every possible embodiment since describing every possible embodiment would be impractical. In light of the teachings and disclosures herein, numerous alternative embodiments may be implemented.

It should be understood that, unless a term is expressly defined in this patent application using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent application.

As further discussed in detail below, a highlight video recording system is described that may automatically generate highlight video compilation clips from one or more video clips. The video clips may have one or more frames that are tagged with data upon the occurrence of a respective physical event. To accomplish this, one or more sensors may measure sensor parameter values as the physical events occur. Thus, upon a physical event occurring having a certain importance or magnitude, one or more associated sensor parameter values may exceed one or more threshold sensor parameter values or match a stored motion signature associated with a type of motion. This may in turn cause one or more video clip frames to be tagged with data indicating the video frame within the video clip when the respective physical event occurred. Using the tagged data frames in each of the video clips, portions of one or more video clips may be automatically selected for generation of highlight video compilation clips. The highlight video compilation clips may include recordings of each of the physical events that caused the video clip frames to be tagged with data.

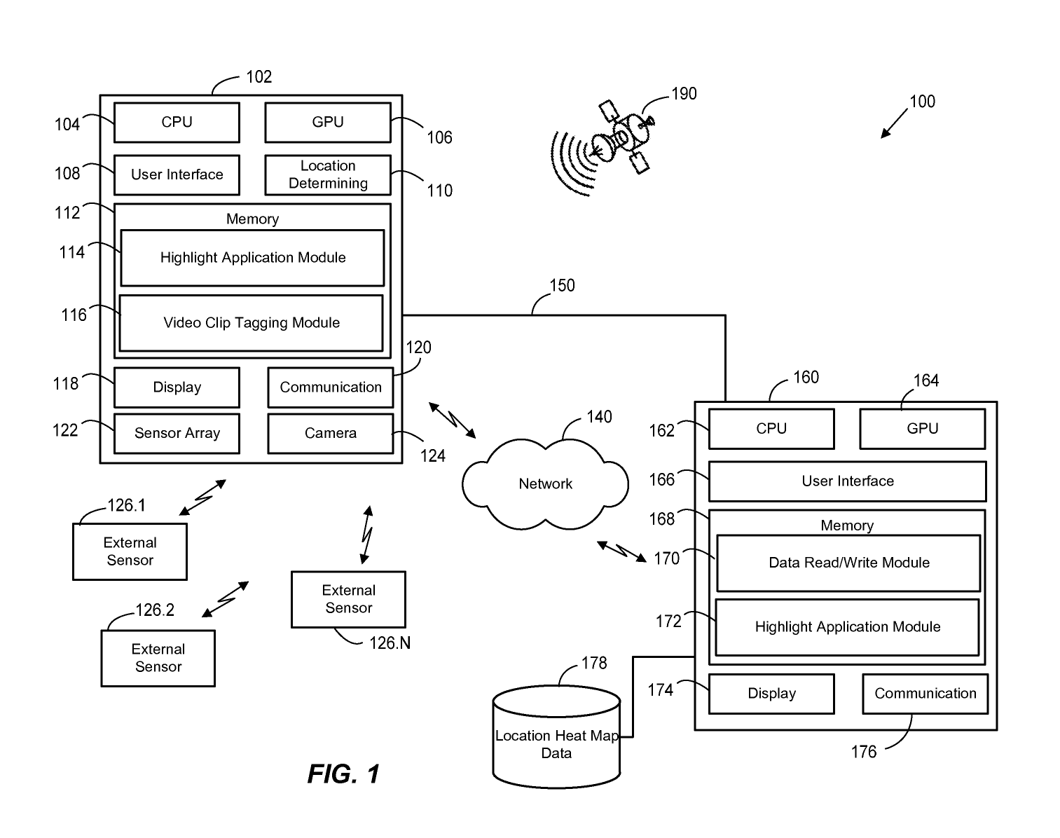

FIG. 1 is a block diagram of an exemplary highlight video recording system 100 in accordance with an embodiment of the present disclosure. Highlight video recording system 100 includes a recording device 102, a communication network 140, a computing device 160, a location heat map database 178, and ‘N’ number of external sensors 126.1-126.N.

Each of recording device 102, external sensors 126.1-126.N, and computing device 160 may be configured to communicate with one another using any suitable number of wired and/or wireless links in conjunction with any suitable number and type of communication protocols.

Communication network 140 may include any suitable number of nodes, additional wired and/or wireless networks, etc., in various embodiments. For example, in an embodiment, communication network 140 may be implemented with any suitable number of base stations, landline connections, internet service provider (ISP) backbone connections, satellite links, public switched telephone network (PSTN) connections, local area networks (LANs), metropolitan area networks (MANs), wide area networks (WANs), any suitable combination of local and/or external network connections, etc. To provide further examples, communications network 140 may include wired telephone and cable hardware, satellite, cellular phone communication networks, etc. In various embodiments, communication network 140 may provide one or more of recording device 102, computing device 160, and/or one or more of external sensors 126.1-126.N with connectivity to network services, such as Internet services and/or access to one another.

Communication network 140 may be configured to support communications between recording device 102, computing device 160, and/or one or more of external sensors 126.1-126.N in accordance with any suitable number and type of wired and/or wireless communication protocols. Examples of suitable communication protocols may include personal area network (PAN) communication protocols (e.g., BLUETOOTH), Wi-Fi communication protocols, radio frequency identification (RFID) and/or a near field communication (NFC) protocols, cellular communication protocols, Internet communication protocols (e.g., Transmission Control Protocol (TCP) and Internet Protocol (IP)), etc.

Alternatively or in addition to communication network 140, wired link 150 may include any suitable number of wired buses and/or wired connections between recording device 102 and computing device 160. Wired link 150 may be configured to support communications between recording device 102 and computing device 160 in accordance with any suitable number and type of wired communication protocols. Examples of suitable wired communication protocols may include LAN communication protocols, Universal Serial Bus (USB) communication protocols, Peripheral Card Interface (PCI) communication protocols, THUNDERBOLT communication protocols, DisplayPort communication protocols, etc.

Recording device 102 may be implemented as any suitable type of device configured to record videos and/or images. In some embodiments, recording device 102 may be implemented as a portable and/or mobile device. Recording device 102 may be implemented as a mobile computing device (e.g., a smartphone), a personal digital assistant (PDA), a tablet computer, a laptop computer, a wearable electronic device, etc. Recording device 102 may include a central processing unit (CPU) 104, a graphics processing unit (GPU) 106, a user interface 108, a location determining component 110, a memory unit 112, a display 118, a communication unit 120, a sensor array 122, and a camera unit 124.

User interface 108 may be configured to facilitate user interaction with recording device 102. For example, user interface 108 may include a user-input device such as an interactive portion of display 118 (e.g., a “soft” keyboard displayed on display 118), an external hardware keyboard configured to communicate with recording device 102 via a wired or a wireless connection (e.g., a BLUETOOTH keyboard), an external mouse, or any other suitable user-input device.

Display 118 may be implemented as any suitable type of display that may be configured to facilitate user interaction, such as a capacitive touch screen display, a resistive touch screen display, etc. In various aspects, display 118 may be configured to work in conjunction with user interface 108, CPU 104, and/or GPU 106 to detect user inputs upon a user selecting a displayed interactive icon or other graphic, to identify user selections of objects displayed via display 118, etc.

Location determining component 110 may be configured to utilize any suitable communications protocol to facilitate determining a geographic location of recording device 102. For example, location determining component 110 may communicate with one or more satellites 190 and/or wireless transmitters in accordance with a Global Navigation Satellite System (GNSS) to determine a geographic location of recording device 102. Wireless transmitters are not illustrated in FIG. 1, but may include, for example, one or more base stations implemented as part of communication network 140.

For example, location determining component 110 may be configured to utilize “Assisted Global Positioning System” (A-GPS), by receiving communications from a combination of base stations and/or from satellites 190. Examples of suitable global positioning communications protocol may include Global Positioning System (GPS), the GLONASS system operated by the Russian government, the Galileo system operated by the European Union, the BeiDou system operated by the Chinese government, etc.

Communication unit 120 may be configured to support any suitable number and/or type of communication protocols to facilitate communications between recording device 102, computing device 160, and/or one or more external sensors 126.1-126.N. Communication unit 120 may be implemented with any combination of suitable hardware and/or software and may utilize any suitable communication protocol and/or network (e.g., communication network 140) to facilitate this functionality. For example, communication unit 120 may be implemented with any number of wired and/or wireless transceivers, network interfaces, physical layers, etc., to facilitate any suitable communications for recording device 102 as previously discussed.

Communication unit 120 may be configured to facilitate communications with one or more of external sensors 126.1-126.N using a first communication protocol (e.g., BLUETOOTH) and to facilitate communications with computing device 160 using a second communication protocol (e.g., a cellular protocol), which may be different than or the same as the first communication protocol. Communication unit 120 may be configured to support simultaneous or separate communications between recording device 102, computing device 160, and/or one or more external sensors 126.1-126.N. For example, recording device 102 may communicate in a peer-to-peer mode with one or more external sensors 126.1-126.N while communicating with computing device 160 via communication network 140 at the same time, or at separate times.

In facilitating communications between recording device 102, computing device 160, and/or one or more external sensors 126.1-126.N, communication unit 120 may receive data from and transmit data to computing device 160 and/or one or more external sensors 126.1-126.N. For example, communication unit 120 may receive data representative of one or more sensor parameter values from one or more external sensors 126.1-126.N. To provide another example, communication unit 120 may transmit data representative of one or more video clips or highlight video compilation clips to computing device 160. CPU 104 and/or GPU 106 may be configured to operate in conjunction with communication unit 120 to process and/or store such data in memory unit 112.

Sensor array 122 may be implemented as any suitable number and type of sensors configured to measure, monitor, and/or quantify any suitable type of physical event in the form of one or more sensor parameter values. Sensor array 122 may be positioned to determine one or more characteristics of physical events experienced by recording device 102, which may be advantageously mounted or otherwise positioned depending on a particular application. These physical events may also be recorded by camera unit 124. For example, recording device 102 may be mounted to a person undergoing one or more physical activities such that one or more sensor parameter values collected by sensor array 122 correlate to the physical activities as they are experienced by the person wearing recording device 102. Sensor array 122 may be configured to perform sensor measurements continuously or in accordance with any suitable recurring schedule, such as once per every 10 seconds, once per 30 seconds, etc.

Examples of suitable sensor types implemented by sensor array 122 may include one or more accelerometers, gyroscopes, perspiration detectors, compasses, speedometers, magnetometers, barometers, thermometers, proximity sensors, light sensors, Hall Effect sensors, electromagnetic radiation sensors (e.g., infrared and/or ultraviolet radiation sensors), humistors, hygrometers, altimeters, biometrics sensors (e.g., heart rate monitors, blood pressure monitors, skin temperature monitors), foot pods, microphones, etc.

External sensors 126.1-126.N may be substantially similar implementations of, and perform substantially similar functions as, sensor array 122. Therefore, only differences between external sensors 126.1-126.N and sensor array 122 will be further discussed herein.

External sensors 126.1-126.N may be located separate from and/or external to recording device 102. For example, recording device 102 may be mounted to a user's head to provide a point-of-view (POV) video recording while the user engages in one or more physical activities. Continuing this example, one or more external sensors 126.1-126.N may be worn by the user at a separate location from the mounted location of recording device 102, such as in a position commensurate with a heart rate monitor, for example.

In addition to performing the sensor measurements and generating sensor parameter values, external sensors 126.1-126.N may also be configured to transmit data representative of one or more sensor parameter values, which may in turn be received and processed by recording device 102 via communication unit 112. Again, external sensors 126.1-126.N may be configured to transmit this data in accordance with any suitable number and type of communication protocols.

In some embodiments, external sensors 126.1-126.N may be configured to perform sensor measurements continuously or in accordance with any suitable recurring schedule, such as once per every 10 seconds, once per 30 seconds, etc. In accordance with such embodiments, external sensors 126.1-126.N may also be configured to generate one or more sensor parameter values based upon these measurements and/or transmit one or more sensor parameter values in accordance with the recurring schedule or some other schedule.

For example, external sensors 126.1-126.N may be configured to perform sensor measurements, generate one or more sensor parameter values, and transmit one or more sensor parameter values every 5 seconds or on any other suitable transmission schedule. To provide another example, external sensors 126.1-126.N may be configured to perform sensor measurements and generate one or more sensor parameter values every 5 seconds, but to transmit aggregated groups of sensor parameter values every minute, two minutes, etc. Reducing the time of recurring data transmissions may be particularly useful, when, for example, external sensors 126.1-126.N utilize a battery power source, as such a configuration may advantageously reduce power consumption.

In other embodiments, external sensors 126.1-126.N may be configured to transmit these one or more sensor parameter values only when the one or more sensor parameter values meet or exceed a threshold sensor parameter value. In this way, transmissions of one or more sensor parameter values may be further reduced such that parameter values are only transmitted in response to physical events of a certain magnitude. Again, restricting the transmission of sensor parameter values in this way may advantageously reduce power consumption.

In embodiments, CPU 104 may evaluate the data from external sensors 126.1-126.N based on an activity type. For instance, memory 112 may include profiles for basketball, baseball, tennis, snowboarding, skiing, etc. The profiles may enable CPU 104 to give additional weight to data from certain external sensors 126.1-126.N. For instance, CPU 104 may be able to identify a basketball jump shot based on data from external sensors 126.1-126.N worn on the user's arms, legs or that determine hang time. Similarly, CPU 104 may be able to identify a baseball or tennis swing based on data from external sensors 126.1-126.N worn on the user's arms. CPU 104 may be able to identify a hang time and/or velocity for snowboarders and skiers based on data from external sensors 126.1-126.N worn on the user's torso or fastened to a snowboarding or skiing equipment.

The one or more sensor parameter values measured by sensor array 122 and/or external sensors 126.1-126.N may include metrics corresponding to a result of a measured physical event by the respective sensor. For example, if external sensor 126.1 is implemented with an accelerometer to measure acceleration, then the sensor parameter value may take the form of ‘X’ m/s², in which case X may be considered a sensor parameter value. To provide another example, if external sensor 126.1 is implemented with a heart monitoring sensor, then the sensor parameter value may take the form of ‘Y’ beats-per-minute (BPM), in which case Y may be considered a sensor parameter value. To provide yet another example, if external sensor 126.1 is implemented with an altimeter, then the sensor parameter value may take the form of an altimetry of ‘Z’ feet, in which case Z may be considered a sensor parameter value. To provide still another example, if external sensor 126.1 is implemented with a microphone, then the sensor parameter value may take the form of ‘A’ decibels, in which case A may be considered a sensor parameter value.

Camera unit 124 may be configured to capture pictures and/or videos. Camera unit 124 may include any suitable combination of hardware and/or software such as a camera lens, image sensors, optical stabilizers, image buffers, frame buffers, charge-coupled devices (CCDs), complementary metal oxide semiconductor (CMOS) devices, etc., to facilitate this functionality.

In various embodiments, CPU 104 and/or GPU 106 may be configured to determine a current time from a real-time clock circuit, by receiving a network time via communication unit 120 (e.g., via communication network 140), and/or by processing timing data received via GNSS communications. In various embodiments, CPU 104 and/or GPU 106 may generate timestamps and/or store the generated timestamps in a suitable portion of memory unit 112. For example, CPU 104 and/or GPU 106 may generate timestamps as sensor parameter values are received from one or more external sensors 126.1-126.N and/or as sensor parameter values are measured and generated via sensor array 122. In this way, CPU 104 and/or GPU 106 may later correlate data received from one or more external sensors 126.1-126.N and/or measured via sensor array 122 to the timestamps to determine when one or more data parameter values were measured by one or more external sensors 126.1-126.N and/or sensor array 122. Thus, CPU 104 and/or GPU 106 may also determine, based upon this timestamp data, when one or more physical events occurred that resulted in the generation of the respective sensor parameter values.

In various embodiments, CPU 104 and/or GPU 106 may be configured to tag one or more portions of video clips recorded by camera unit 124 with one or more data tags. These data tags may be later used to automatically create video highlight compilations, which will be further discussed in detail below. The data tags may be any suitable type of identifier that may later be recognized by a processor performing post-processing on video clips stored in memory unit 112. For example, the data tags may include information such as a timestamp, type of physical event, sensory information associated with the physical event, a sensor parameter value, a sequential data tag number, a geographic location of recording device 102, the current time, etc. GPS signals provide very accurate time information that may be particularly helpful to generate highlight video clips recorded by camera unit 124. In some embodiments, the processor later recognizing the data tag may be CPU 104 and/or GPU 106. In other embodiments, the processor recognizing the data tag may correspond to another processor, such as CPU 162, for example, implemented by computing device 160.

CPU 104 and/or GPU 106 may be configured to add one or more data tags to video clips captured by camera unit 124 by adding the data tags to one or more video frames of the video clips. The data tags may be added to the video clips while being recorded by camera unit 124 or any suitable time thereafter. For example, CPU 104 and/or GPU 106 may be configured to add data tags to one or more video clip frames as it is being recorded by camera unit 124. To provide another example, CPU 104 and/or GPU 106 may be configured to write one or more data tags to one or more video clip frames after the video clip has been stored in memory unit 112. The data tags may be added to the video clips using any suitable technique, such as being added as metadata attached to the video clip file data, for example.

In various embodiments, CPU 104 and/or GPU 106 may be configured to generate the data tags in response to an occurrence of one or more physical events and/or a geographic location of recording device 102. For example, while a user is wearing recording device 102 and/or one or more external sensors 126.1-126.N, CPU 104 and/or GPU 106 may compare one or more sensor parameter values generated by sensor array 122 and/or external sensors 126.1-126.N to one or more threshold sensor parameter values, which may be stored in any suitable portion of memory unit 112. In embodiments, upon the one or more sensor parameter values exceeding a corresponding threshold sensor parameter value or matching a stored motion signature associated with a type of motion, CPU 104 and/or GPU 106 may generate one or more data tags and add the one or more data tags to a currently-recorded video clip frame. CPU 104 and/or GPU 106 may add the one or more data tags to the video clip at a chronological video clip frame position corresponding to when each physical event occurred that was associated with the sensor parameter value exceeding the threshold sensor parameter value or matching a stored motion signature associated with a type of motion. In this way, CPU 104 and/or GPU 106 may mark the time within one or more recorded video clips corresponding to the occurrence of one or more physical events of a particular interest. In embodiments, the data tags may be added to a data table associated with the video clip.

In embodiments, memory unit 112, 168 may store one or more motion signatures associated with various types of motions. Each motion signature includes a plurality of unique sensor parameter values indicative of a particular type of motion. For instance, motion signatures may be associated with a subject performing an athletic movement, such as swinging an object (e.g., baseball bat, tennis racket, etc.). The stored motion signature may be predetermined for a subject based on typical sensor parameter values associated with a type of motion or calibrated for a subject. A subject may calibrate a motion signature by positioning recording device 102 and/or any external sensors 126.1-126.N that may be used during filming video clips in the appropriate locations and then performing the motion of interest in a calibration mode, in which the sensor parameter values generated by the one or more sensors 122, 126.1-126.N are determined and stored.

CPU 104, 162 may compare sensor parameter values with the stored motion signatures to identify a type of motion and determine at least one of the first event time and the second event time. In embodiments, CPU 104, 162 may compare sensor parameter values with the stored motion signatures, which include a plurality of unique sensor parameter values, by overlaying the two sets of data and determining the extent of similarity between the two sets of data. For instance, if a stored motion signature for a subject performing a baseball swing includes five sensor parameter values, CPU 104, 162 may determine the occurrence of a baseball swing by the subject in one or more video clips if at least four of five sensor parameter values match or are similar to the stored motion signature.

CPU 104, 162 may determine at least one of the first event time and the second event time based on the result of comparing sensor parameter values with stored motion signatures. For instance, the subject depicted in video clips may take a baseball swing to hit a baseball in the top of the first inning and throw a baseball to first base to throw out a runner while filing in the bottom of the inning. CPU 104, 162 may determine the moment of the baseball swing as the first event time and the moment of throwing the baseball to first as the second event time.

In various embodiments, CPU 104 and/or GPU 106 may be configured to generate the data tags in response to characteristics of the recorded video clips. For example, as a post-processing operation, CPU 104 and/or GPU 106 may be configured to analyze one or more video clips for the presence of certain audio patterns that may be associated with a physical event. To provide another example, CPU 104 and/or GPU 106 may be configured to associate portions of one or more video clips by analyzing motion flow within one or more video clips, determining whether specific objects are identified in the video data, etc.

In some embodiments, the data tags may be associated with one or more sensor parameter values exceeding a threshold sensor parameter value or matching a stored motion signature associated with a type of motion. In other embodiments, however, the data tags may be generated and/or added to one or more video clips stored in memory unit 112 based upon a geographic location of recording device 102 while each frame of the video clip was recorded. In various embodiments, CPU 102 and/or GPU 104 may be configured to access and/or download data stored in location heat map database 178 through communications with computing device 160. CPU 102 and/or GPU 104 may be configured to compare one or more data tags indicative of geographic locations of recording device 102 throughout the recording of a video clip to data stored in location heat map database 178. In other embodiments, which will be discussed in further detail below, CPU 102 and/or GPU 104 may be configured to send one or more video clips to computing device 160, in which case computing device 160 may access location heat map database 178 to perform similar functions.

For example, location heat map database 178 may be configured to store any suitable type of location data indicative of areas of particular interest. For example, location heat map database 178 may include several geographic locations defined as latitude, longitude, and/or altitude coordinate ranges forming one or more two-dimensional or three-dimensional geofenced areas. These geofenced areas may correspond to any suitable area of interest based upon the particular event for which video highlights are sought to be captured. For example, the geofenced areas may correspond to a portion of a motorcycle racetrack associated with a hairpin turn, a certain altitude and coordinate range associated with a portion of a double-black diamond ski hill, a certain area of water within a body of water commonly used for water sports, a last-mile marker of a marathon race, etc.

CPU 104 and/or GPU 106 may be configured to compare tagged geographic location data included in one or more frames of a video clip that was stored while the video was being recorded to one or more such geofenced areas. If the location data corresponds to a geographic location within one of the geofenced areas, then CPU 104 and/or GPU 106 may flag the video clip frame, for example, by adding another data tag to the frame similar to those added when one or more of the sensor parameter values exceed a threshold sensor parameter value or match a stored motion signature associated with a type of motion. In this way, CPU 104 and/or GPU 106 may later identify portions of video clip that may be of particular interest based upon the sensor parameter values and/or the location of recording device 102 measured while the video clips were recorded. The CPU 104 and/or GPU 106 may compare the geographic location data of a video clip with geofenced areas while the video clips are being recorded by camera unit 124 or any suitable time thereafter. In embodiments, recording device 102 and external sensors 126.1-126.N may include orientation sensors, light, and/or transmitter and CPU 104, 162 may determine whether the subject is in the frame on the video clips. For instance, CPU 104, 162 may determine the orientation of recording device 102 and position of a subject wearing an external sensor 126.1-126.N to determine whether the recording device 102 is aimed at the subject.

CPU 104 and/or GPU 106 may be configured to communicate with memory unit 112 to store to and read data from memory unit 112. In accordance with various embodiments, memory unit 112 may be a computer-readable non-transitory storage device that may include any combination of volatile (e.g., a random access memory (RAM), or non-volatile memory (e.g., battery-backed RAM, FLASH, etc.). Memory unit 112 may be configured to store instructions executable on CPU 104 and/or GPU 106. These instructions may include machine readable instructions that, when executed by CPU 104 and/or GPU 106, cause CPU 104 and/or GPU 106 to perform various acts. Memory unit 112 may also be configured to store any other suitable data, such as data received from one or more external sensors 126.1-126.N, data measured via sensor array 122, one or more images and/or video clips recorded by camera unit 124, geographic location data, timestamp information, etc.

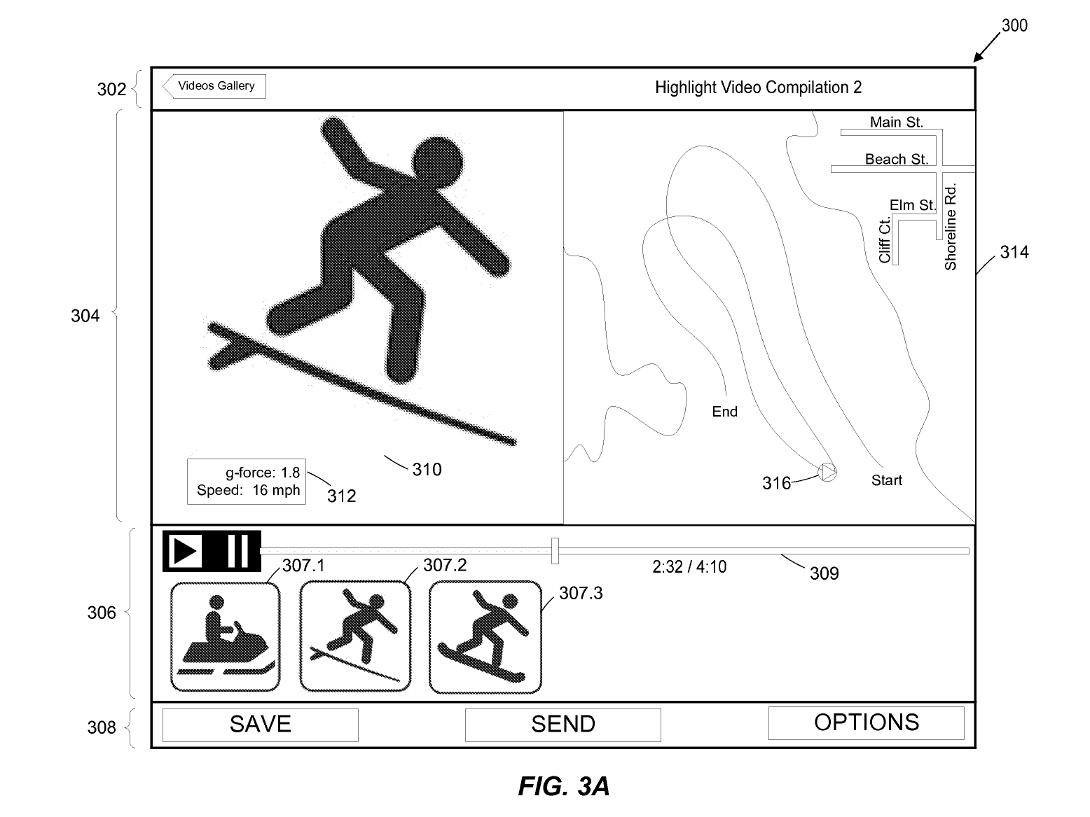

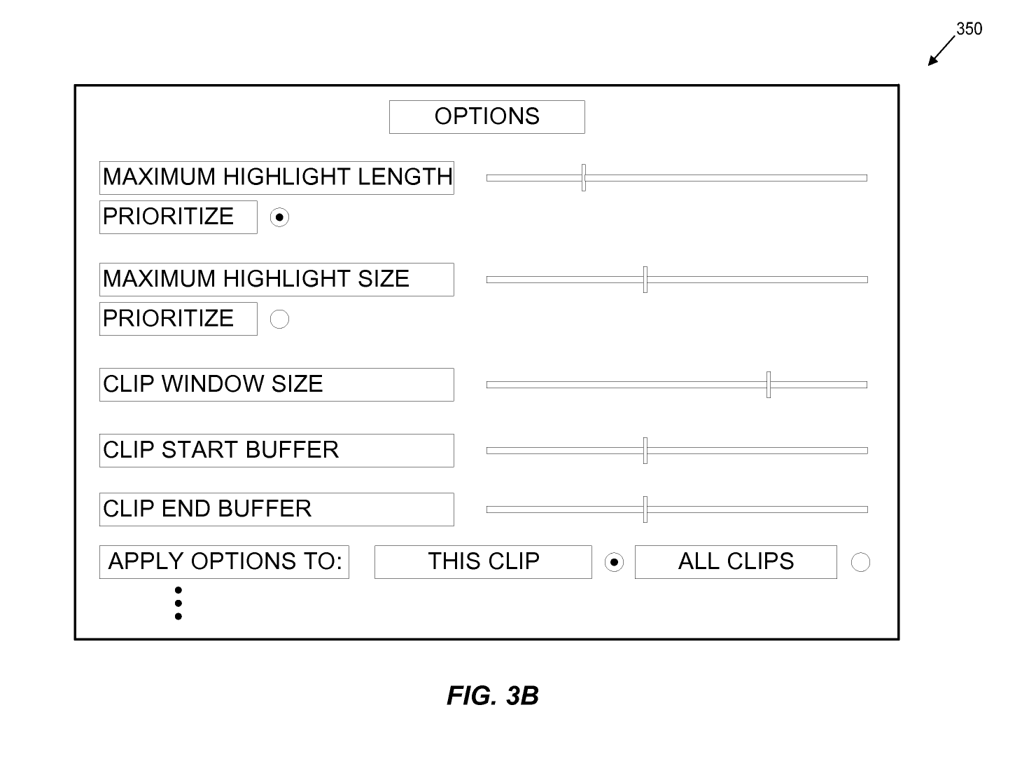

Highlight application module 114 is a portion of memory unit 112 configured to store instructions, that when executed by CPU 104 and/or GPU 106, cause CPU 104 and/or GPU 106 to perform various acts in accordance with applicable embodiments as described herein. For example, in various embodiments, instructions stored in highlight application module 114 may facilitate CPU 104 and/or GPU 106 to perform functions such as, for example, providing a user interface screen to a user via display 118. The user interface screen is further discussed with reference to FIGS. 3A-B, but may include, for example, displaying one or more video clips using the tagged data, facilitating the creation and/or editing of one or more video clips, facilitating the generation of highlight video compilations from several video clips, modifying settings used in the creation of highlight video compilations from the tagged data, etc.

In some embodiments, instructions stored in highlight application module 114 may cause one or more portions of recording device 102 to perform an action in response to receiving one or more sensor parameter values and/or receiving one or more sensor parameter values that exceed one or more respective threshold sensor parameter values or match a stored motion signature associated with a type of motion. For example, upon receiving one or more sensor parameter values exceeding a threshold sensor parameter value or matching a stored motion signature associated with a type of motion, instructions stored in highlight application module 114 may cause camera unit 124 to change a zoom level, for example.

Video clip tagging module 116 is a portion of memory unit 112 configured to store instructions, that when executed by CPU 104 and/or GPU 106, cause CPU 104 and/or GPU 106 to perform various acts in accordance with applicable embodiments as described herein. For example, in various embodiments, instructions stored in video clip tagging module 116 may cause CPU 104 and/or GPU 106 to perform functions such as, for example, receiving and/or processing one or more sensor parameter values, comparing one or more sensor parameter values to threshold sensor parameter values, tagging one or more recorded video clip frames with one or more data tags to indicate that one or more sensor parameter values have exceeded respective threshold sensor parameter values or have matched a stored motion signature associated with a type of motion, tagging one or more recorded video clip frames with one or more data tags to indicate a location of recording device 102, etc.

In some embodiments, the information and/or instructions stored in highlight application module 114 and/or video clip tagging module 116 may be setup upon the initial installation of a corresponding application. In such embodiments, the application may be installed in addition to an operating system implemented by recording device 102. For example, a user may download and install the application from an application store via communication unit 120 in conjunction with user interface 108. Application stores may include, for example, Apple Inc.'s App Store, Google Inc.'s Google Play, Microsoft Inc.'s Windows Phone Store, etc., depending on the operating system implemented by recording device 102.

In other embodiments, the information and/or instructions stored in highlight application module 114 may be integrated as a part of the operating system implemented by recording device 102. For example, a user may install the application via an initial setup procedure upon initialization of recording device 102, as part of setting up a new user account on recording device 102, etc.

CPU 104 and/or 106 may access instructions stored in highlight application module 114 and/or video clip tagging module 116 to implement any suitable number of routines, algorithms, applications, programs, etc., to facilitate the functionality as described herein with respect to the applicable embodiments.

Computing device 160 may be implemented as any suitable type of device configured to support recording device 102 in creating video clip highlights as further discussed herein and/or to facilitate video editing. In some embodiments, computing device 160 may be implemented as an external computing device, i.e., as an external component with respect to recording device 102. Computing device 160 may be implemented as a smartphone, a personal computer, a personal digital assistant (PDA), a tablet computer, a laptop computer, a server, a wearable electronic device, etc.

Computing device 160 may include a CPU 162, a GPU 164, a user interface 166, a memory unit 168, a display 174, and a communication unit 176. CPU 162, GPU 164, user interface 166, memory unit 168, display 174, and communication unit 176 may be substantially similar implementations of, and perform substantially similar functions as, CPU 104, GPU 106, user interface 180, memory unit 112, display 118, and communication unit 120, respectively. Therefore, only differences between CPU 162, GPU 164, user interface 166, memory unit 168, display 174, communication unit 176, and CPU 104, GPU 106, user interface 180, memory unit 112, display 118, and communication unit 120, respectively, will be further discussed herein.

Data read/write module 170 is a portion of memory unit 168 configured to store instructions, that when executed by CPU 162 and/or GPU 164, cause CPU 162 and/or GPU 164 to perform various acts in accordance with applicable embodiments as described herein. For example, in various embodiments, instructions stored in data read/write module 170 may facilitate CPU 162 and/or GPU 164 to perform functions such as, for example, facilitating communications between recording device 102 and computing device 160 via communication unit 176, receiving one or more video clips having tagged data from recording device 102, receiving one or more highlight video compilations from recording device 102, reading data from and writing data to location heat map database 178 using any suitable number of wired and/or wireless connections, sending heat map data retrieved from location heat map database 178 to recording device 102, etc.

Although location heat map database 178 is illustrated in FIG. 1 as being coupled to computing device 160 via a direct wired connection, various embodiments include computing device 160 reading data from and writing data to location heat map database 178 using any suitable number of wired and/or wireless connections. For example, computing device 160 may access location heat map database 178 using communication unit 176 via communication network 140.

Highlight application module 172 is a portion of memory unit 168 configured to store instructions, that when executed by CPU 162 and/or GPU 164, cause CPU 162 and/or GPU 164 to perform various acts in accordance with applicable embodiments as described herein. For example, in various embodiments, instructions stored in highlight application module 172 may facilitate CPU 162 and/or GPU 164 to perform functions such as, for example, displaying a user interface screen to a user via display 174. The user interface screen is further discussed with reference to FIGS. 3A-B, but may include, for example, displaying one or more video clips using the tagged data, facilitating the creation and/or editing of one or more video clips, facilitating the generation of highlight video compilations from several data tagged video clips, modifying settings used in the creation of highlight video compilations from data tagged video clips, etc.

Although each of the components in FIG. 1 are illustrated as separate units or modules, any components integrated as part of recording device 102 and/or computing device 160 may be combined and/or share functionalities. For example, CPU 104, GPU 106, and memory unit 112 may be integrated as a single processing unit. Furthermore, although connections are not shown between the individual components of recording device 102 and computing device 160, recording device 102 and/or computing device 160 may implement any suitable number of wired and/or wireless links to facilitate communication and interoperability between their respective components. For example, memory unit 112, communication unit 120, and/or display 118 may be coupled via wired buses and/or wireless links to CPU 104 and/or GPU 106 to facilitate communications between these components and to enable these components to accomplish their respective functions as described throughout the present disclosure. Furthermore, although FIG. 1 illustrates single memory units 112 and 168, recording device 102 and/or computing device 160 may implement any suitable number and/or combination of respective memory systems.

Furthermore, the embodiments described herein may be performed by recording device 102, computing device 160, or a combination of recording device 102 working in conjunction with computing device 160. For example, as will be further discussed below with reference to FIGS. 3A-B, either recording device 102 or computing device 160 may be implemented to generate one or more highlight video compilations, to change settings regarding how highlight video compilations are recorded and/or how data tags within video clips impact the creation of highlight video compilations, etc.

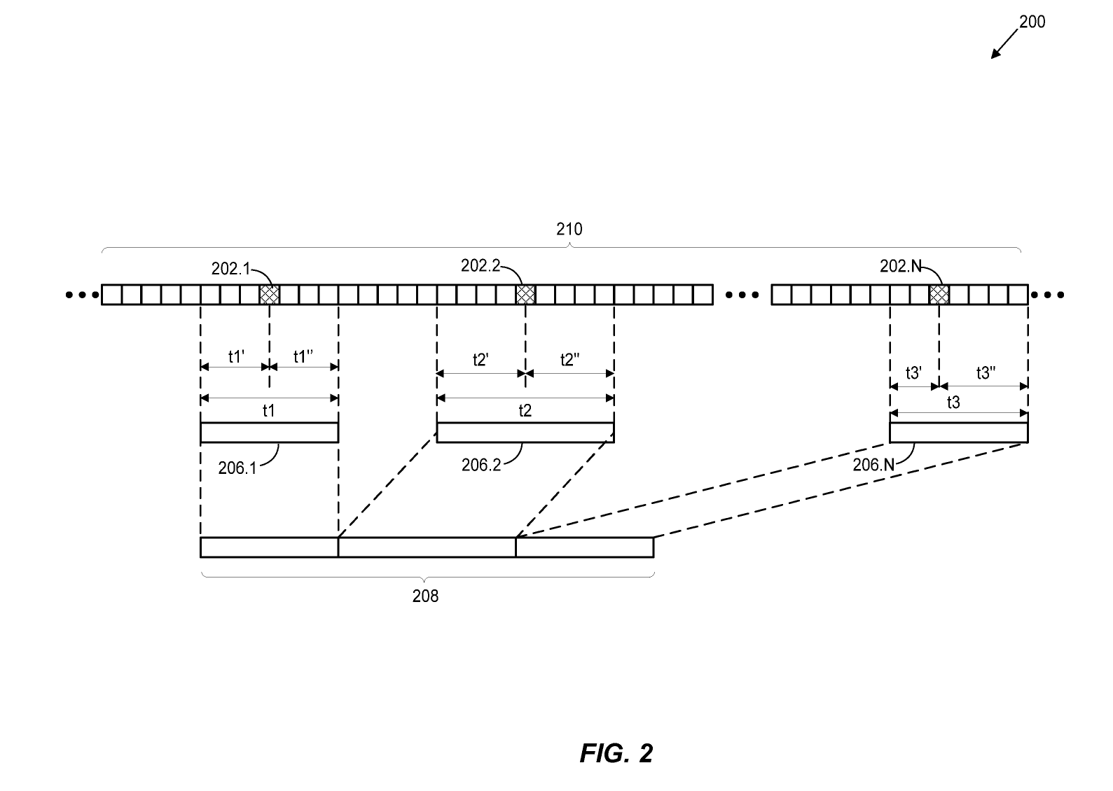

FIG. 2 is a block diagram of an exemplary highlight video compilation system 200 from a single camera according to an embodiment. As shown in FIG. 2, highlight video compilation system 200 is made up of ‘N’ number of separate video clips 206.1-206.N. Although three video clips are illustrated in FIG. 2, any suitable number of video clips may be used in the creation of highlight video compilation 208.

As shown in FIG. 2, a video clip 201 includes N number of tagged frames 202.1-202.N. In an embodiment, video clip 201 may have been recorded by a camera such as camera unit 124, for example, as shown in FIG. 1. Continuing this example, each of tagged data frames 202.1-202.N may include tagged data such as a sequential data tag number, for example, written to each respective tagged data frame by CPU 104 and/or GPU 106 based on a parameter value generated by a sensor. For instance, CPU 104 and/or GPU 106 may include tag data at the time one or more sensor parameter values exceeded a threshold sensor parameter value or matched a stored motion signature associated with a type of motion.

As shown in FIG. 2, each of the video clips 206.1-206.N may then be extracted from the video clip 201 having a corresponding video time window, which may represent the overall playing time of each respective video clip 206.1-206.N. For example, video clip 206.1 has a time window of t1 seconds, video clip 206.2 has a time window of t2 seconds, and video clip 206.N has a time window of t3 seconds. Highlight video compilation 208, therefore, has an overall length of t1+t2+t3.

In embodiments, a physical event of interest may include a first physical event and a second physical event that occurs shortly after the first physical event. For instance, where a physical event of interest a subject shooting a basketball after it is dribbled, the first physical event is a bounce of the basketball on the floor and the second physical event is the basketball shot. The CPU 104, 162 may determine a basketball player dribbled a basketball one or more times before shooting the basketball and automatically identify the sequence of physical events in which a sensor parameter value exceeds a threshold sensor parameter value as a physical event of interest. If the activity relates to a basketball dribbled one per second, the period of time between the physical events is one second. Similarly, where a physical event of interest is a subject performing a challenging jump, the first physical event is the moment when the subject went into the air and the second physical event is the moment when the subject touched the ground. The CPU 104, 162 may determine a skier jumped off of a ramp before landing onto a landing area and automatically identify the sequence of each events in which a sensor parameter value exceeds a threshold sensor parameter value as a physical event of interest. If the activity relates to a subject spending five seconds in the air during a high jump, the period of time between the physical events is five seconds.

To ensure that the entire moment is captured in the highlight video compilation 208, computing device 160 may determine from the one or more video clips 201 a second video time window that begins immediately after the first video time window ends such that the highlight video compilation 208 includes the first physical event and the second physical event without interruption. One or more video clips 201 of the physical event of interest may include a series of multiple tagged frames associated with a series of sensor parameter values during the physical event. In embodiments, the multiple tagged frames may be associated with moments when a sensor parameter value exceeded a threshold sensor parameter value. In embodiments, the CPU 104, 162 may automatically identify the series of sensor parameter values exceeding a threshold sensor parameter value as associated with a physical event of interest or matching a stored motion signature associated with a type of motion. For instance, CPU 104, 162 may extract from the video clip 201 multiple video clips 206.1-206.N without any interruptions or gaps in the video clip for the physical event associated with a series of multiple tagged frames associated with a series of sensor parameter values exceeding a threshold sensor parameter value or matching a stored motion signature associated with a type of motion.

In embodiments, the CPU 104, 162 may determine a rate of change of sensor parameter values and use the determined rate of change to identify a physical event. For example, CPU 104, 162 may take an average of or apply a filter to sensor parameter values to obtain a simplified sensor parameter value data and determine the rate of change (slope) of the simplified sensor parameter value data. CPU 104, 162 may then use a change in the determined rate of change (slope) to identify a first event time or a second event time. For instance, the determined rate of change (slope) may be positive (increasing) prior to a physical event and negative (decreasing) after the physical event. CPU 104, 162 may determine the moment of the change in determined rate of change (slope) as the first event time or a second event time.

In some embodiments, the clip start buffer time and the clip end buffer time in one or more of video clips 206.1-206.N may be equal to one another, as is the case in video clips 206.1 and 206.2. That is, start buffer time t1′ is equal to end buffer time t1″, which are each half of time window t1. In addition, start buffer time t2′ is equal to end buffer time t2″, which are each half of time window t2. In such a case, the physical event times corresponding to an occurrence of each event that caused the one or more respective parameter values to exceed a respective threshold sensor parameter value, or match a stored motion signature associated with a type of motion, are centered within each respective time window t1 and t2.

In other embodiments, the clip start buffer time and the clip end buffer time in one or more of video clips 206.1-206.N may not be equal to one another, as is the case in video clip 206.N. That is, start buffer time t3′ is not equal to end buffer time t3″, which are each unequal portions of time window t3. In such as case, the physical event time corresponding to the occurrence of the event that caused the one or more respective parameter values to exceed a respective threshold sensor parameter value, or match a stored motion signature associated with a type of motion, is not centered within the respective time window t3, as the clip start buffer time t3′ is not equal to the clip end buffer time t3″. As will be further discussed with reference to FIGS. 3A-B below, the total clip time duration, the clip start buffer time, and the clip end buffer time may have default values that may be adjusted by a user.

Once each of the video clips 206.1-206.N is extracted from video clip 201, the video clips 206.1-206.N may be compiled to generate highlight video compilation 208. Because each physical event that caused the one or more respective parameter values to exceed a respective threshold sensor parameter value or match a stored motion signature associated with a type of motion may also be recorded in each of video clips 206.1-206.N, highlight video compilation 208 may advantageously include each of these separate physical events.

In some embodiments, highlight video compilation 208 may be created after one or more video clips 206.1-206.N have been recorded by a user selecting one or more options in a suitable user interface, as will be further discussed with reference to FIGS. 3A-B.

However, in other embodiments, highlight video compilation 208 may be generated once recording of video clip 201 has been completed in accordance with one or more preselected and/or default settings. For example, upon a user recording video clip 201 with camera unit 124, video clip 201 may be stored to a suitable portion of memory unit 112. For example, in accordance with such embodiments, instructions stored in highlight application module 114 may automatically generate highlight video compilation 208, store highlight video compilation 208 in a suitable portion of memory unit 112, send highlight video compilation 208 to computing device 160, etc.

In still additional embodiments, upon a user recording video clip 201 with camera unit 124, video clip 201 may be sent to computing device 160. In accordance with such embodiments, computing device 160 may store video clip 201 to a suitable portion of memory unit 168. Instructions stored in highlight application module 172 of memory unit 168 may cause CPU 162 and/or GPU 164 to automatically generate highlight video compilation 208, to store highlight video compilation 208 in a suitable portion of memory unit 168, to send highlight video compilation 208 to another device (e.g., recording device 102), etc.

The screens illustrated in FIGS. 3A-3B are examples of screens that may be displayed on a suitable computing device once a corresponding application installed on the suitable computing device is launched by a user in accordance with various aspects of the present disclosure. In an embodiment, the screens illustrated in FIGS. 3A-3B may be displayed by any suitable device, such as devices 102 and/or 160, as shown in FIG. 1, for example. The example screens shown in FIGS. 3A-3B are for illustrative purposes, and the functions described herein with respect to each respective screen may be implemented using any suitable format and/or design without departing from the spirit and scope of the present disclosure.

Furthermore, FIGS. 3A-3B illustrate screens that may include one or more interactive icons, labels, etc. The following user interaction with the screens shown in FIGS. 3A-3B is described in terms of a user “selecting” these interactive icons or labels. This selection may be performed in any suitable manner without departing from the spirit and scope of the disclosure. For example, a user may select an interactive icon or label displayed on a suitable interactive display using an appropriate gesture, such as tapping his/her finger on the interactive display. To provide another example, a user may select an interactive icon or label displayed on a suitable display by moving a mouse pointer over the respective interactive icon or label and clicking a mouse button.

Again, embodiments include the generation of highlight video compilations 208 with and without user interaction. In each of these embodiments, however, a user may utilize the user interface further described with reference to FIGS. 3A-3B. For example, in embodiments in which a user may create highlight video compilations 208, a user may utilize the following user interface by, for example, selecting one or more video clips 201 having one or more tagged data frames 202.1-202.N to create the highlight video compilations 208. However, in embodiments in which the highlight video compilations 208 are automatically generated without user intervention, a user may still choose to further edit the generated highlight video compilations 208, by, for example, changing the overall size and/or length of an automatically generated highlight video compilation 208.

FIG. 3A is a schematic illustration example of a user interface screen 300 used to edit and view highlight videos, according to an embodiment. User interface screen 300 includes portions 302, 304, 306, and 308. User interface screen 300 may include any suitable graphic, information, label, etc., to facilitate a user viewing and/or editing highlight video compilations. Again, user interface screen 300 may be displayed on a suitable display device, such as on display 118 of recording device 102, on display 174 of computing device 160, etc. Furthermore, user interface screen 300 may be displayed in accordance with any suitable user interface and application. For example, if executed on recording device 102, then user interface screen 300 may be displayed to a user via display 118 as part of the execution of highlight application module 114 by CPU 104 and/or GPU 106, in which case selections may be made by a user and processed in accordance with user interface 108. To provide another example, if executed on computing device 160, then user interface screen 300 may be displayed to a user via display 174 as part of the execution of highlight application module 172 by CPU 162 and/or GPU 164, in which case selections may be made by a user and processed in accordance with user interface 166.

Portion 302 may include a name of the highlight video compilation 208 as generated by the application or as chosen by the user. Portion 302 may also include an interactive icon to facilitate a user returning to various portions of the application. For example, a user may select the “Videos Gallery” to view another screen including one or more video clips 206.1-206.N that may have tagged data frames 202.1-202.N. This screen is not shown for purposes of brevity, but may include any suitable presentation of one or more video clips. In this way, a user may further edit the highlight video compilation 208 by selecting and/or removing video clips 206.1-206.N that constitute the highlight video compilation 208. For example, if the automatically generated highlight video compilation includes 12 video clips 206.1-206.N and was 6 minutes long, a user may choose to view the videos gallery to remove several of these video clips 206.1-206.N to reduce the size and length of the highlight video compilation 208.

Portion 304 may include one or more windows allowing a user to view the highlight video compilation and associated tagged data. Portion 304 may include a video window 310, which allows a user to view a currently selected highlight compilation video continuously or on a frame-by-frame basis. For example, as shown in FIG. 3A, the selected highlight video compilation 307.2 is playing in video window 310. Continuing this example, the image shown in video window 310 also corresponds to a frame of highlight video compilation 307.2 corresponding to a time of 2:32.

Portion 304 may also include a display of one or more sensor parameter values, as shown in window 312. Again, highlight video compilation 307.2 may be a compilation of several video clips 202.1-202.N, each having one or more tagged data frames 206.1-206.N. In some embodiments, the one or more sensor parameter values may correspond to the same sensor parameter values that resulted in the currently playing video clip within highlight video compilation 307.2 being tagged with data. For example, as shown in window 312, the sensor parameter values for the currently playing video clip that is part of highlight video compilation 307.2 has a g-force of 1.8 m/s² and a speed of 16 mph. Therefore, the respective thresholds for the g-force and/or speed sensor parameter values may have been below these values, thereby resulting in the currently playing video clip being tagged.

In other embodiments, the one or more sensor parameter values may correspond to different sensor parameter values that resulted in the currently playing video clip within highlight video compilation 307.2 being tagged with data. In accordance with such embodiments, window 312 may display measured sensor parameter values for each frame of one or more video clips within highlight video compilation 307.2 corresponding to the sensor parameter values measured as the video clip was recorded. For example, the video clip playing in video window 310 may have initial measured sensor parameter values of g-force and speed values greater than 1.8 m/s² and 16 mph, respectively. This may have caused an earlier frame of the video clip to have tagged data. To continue this example, the video frame at 2:32, as shown in video window 310, may display one or more sensor parameter values that were measured at a time subsequent to those that caused the video clip to be initially tagged. In this way, once a video clip is tagged and added as part of a highlight video compilation, a user may continue to view sensor parameter values over additional portions (or the entire length) of each video clip in the highlight video compilation.

Portion 304 may include a map window 314 indicating a geographic location of the device recording the currently selected video played in video window 310. For example, the video clip playing at 2:32 may have associated geographic location data stored in one or more video frames. In such a case, the application may overlay this geographic location data onto a map and display this information in map window 314. As shown in map window 314, a trace is displayed indicating a start location, and end location, and an icon 316. The location of icon 316 may correspond to the location of the device recording the video clip as shown in video window 310 at a corresponding playing time of 2:32. The start and end locations may correspond to, for example, the start buffer and stop buffer times, as previously discussed with reference to FIG. 2. In this way, a user may concurrently view sensor parameter value data, video data, and geographic location data using user interface screen 300.

Portion 306 may include a control bar 309 and one or more icons indicative of highlight video compilations 307.1-307.3. In the example show in FIG. 3A, a user may slide the current frame indicator along the control bar 309 to advance between frames shown in video window 310. Again, the video shown in video window 310 corresponds to the presently-selected highlight compilation video 307.2. However, a user may select other highlight compilation videos from portion 306, such as highlight compilation video 307.1 or highlight compilation video 307.3. In such a case, video window 310 would display the respective highlight compilation video 307.1 307.3. The control bar 309 would allow a user to pause, play, and advance between frames of a selected highlight compilation videos 307.1, 307.2 and/or 307.3.

Portion 308 may include one or more interactive icons or labels to allow a user to save highlight compilation videos, to send highlight compilation videos to other devices, and/or to select one or more options used by the application. For example, a user may select the save icon to save a copy of the generated highlight compilation video in a suitable portion of memory 168 on computing device 160. To provide another example, the user may select the send icon to send a copy of the highlight compilation video 307.1, 307.2 and/or 307.3 generated on recording device 102 to computing device 160. To provide yet another example, a user may select the option icon to modify settings or other options used by the application, as will be further discussed below with reference to FIG. 3B. Portion 308 may enable a user to send highlight compilation videos to other devices using “share” buttons associated with social media websites, email, or other medium.

FIG. 3B is a schematic illustration example of a user interface screen 350 used to modify settings, according to an embodiment. In an embodiment, user interface screen 350 is an example of a screen presented to a user upon selection of the option icon in user interface screen 300, as previously discussed with reference to FIG. 3A. User interface screen 350 may include any suitable graphic, information, label, etc., to facilitate a user selecting one or more options for the creation of one or more highlight video compilations. Similar to user interface screen 300, user interface screen 350 may also be displayed on a suitable display device, such as on display 118 of recording device 102, on display 174 of computing device 160, etc.

Furthermore, user interface screen 350 may be displayed in accordance with any suitable user interface and application. For example, if executed on recording device 102, then user interface screen 350 may be displayed to a user via display 118 as part of the execution of highlight application module 114 by CPU 104 and/or GPU 106, in which case selections may be made by a user and processed in accordance with user interface 108. To provide another example, if executed on computing device 160, then user interface screen 350 may be displayed to a user via display 174 as part of the execution of highlight application module 172 by CPU 162 and/or GPU 164, in which case selections may be made by a user and processed in accordance with user interface 166.

As shown in FIG. 3B, user interface screen 350 includes several options to allow a user to modify various settings and to adjust how highlight video compilations 208 are generated from video clips 206.1-206.N having tagged data frames. As previously discussed with reference to FIG. 2, the clip window size (e.g., t3), clip start buffer size (e.g., t3′), and clip end buffer sizes (e.g., t3″) may be adjusted as represented by each respective sliding bar. In addition, user interface screen 350 may allow the maximum highlight video compilation length and respective file size to be changed, as well as any other values related to video capture or storage.

Because higher quality and/or resolution video recordings typically take up a larger amount of data than lower quality and/or resolution video recordings, user interface screen 350 may also allow a user to prioritize one selection over the other. For example, a user may select a maximum highlight video compilation length of two minutes regardless of the size of the data file, as shown by the selection illustrated in FIG. 3B. However, a user may also select a maximum highlight video compilation size of ten megabytes (MB) regardless of the length of the highlight video compilation 208, which may result in a truncation of the highlight video compilation 208 to save data. Such prioritizations may be particularly useful when sharing highlight video compilations 208 over certain communication networks, such as cellular networks, for example.

User interface screen 350 may also provide a user with options on which highlight video compilations 208 to apply the present options, either to the currently selected (or next generated, in the case of automatic embodiments) highlight video compilation 208 or to a current selection of all video clips 206.1-206.N (or all subsequently created highlight video compilations 208 in automatic embodiments).

Again, FIGS. 3A-B each illustrates exemplary user interface screens, which may be implemented using any suitable design. For example, predefined formatted clips may be used as introductory video sequences, ending video sequences, etc. In some embodiments, the relevant application (e.g., highlight application module 172) may include any suitable number of templates that may modify how video highlight clips are generated from video clips and user interface screens 300 and 350 are displayed to a user.

These templates may be provided by the manufacture or developer of the relevant application. In addition to these templates, the application may also include one or more tools to allow a user to customize and/or create templates according to their own preferences, design, graphics, etc. These templates may be saved, published, shared with other users, etc.

Furthermore, although several options are shown in FIG. 3B, these options are not exhaustive or all-inclusive. Additional settings and/or options may be facilitated but are not shown in FIGS. 3A-B for purposes of brevity. For example, user interface 350 may include additional options such as suggesting preferred video clips to be used in the generation of a highlight video compilation 208. These videos may be presented and/or prioritized based upon any suitable number of characteristics, such as randomly selected video clips, a number of video clips taken within a certain time period, etc.

Furthermore, as part of these templates, the application may include one or more predefined template parameters such as predefined formatted clips, transitions, overlays, special effects, texts, fonts, subtitles, gauges, graphic overlays, labels, background music, sound effects, textures, filters, etc., that are not recorded by a camera device, but instead are installed as part of the relevant application.

Any suitable number of the predefined template parameters may be selected by the user such that highlight video compilations 208 may use any aspect of the predefined template parameters in the automatic generation of highlight video compilations 208. These predefined template parameters may also be applied manually, for example, in embodiments in which the highlight video compilations 208 are not automatically generated. For example, the user may select a “star wipe” transition such that automatically generated highlight video compilations 208 apply a star wipe when transitioning between each video clip 206.1-206.N.

To provide another example, a user may select other special effects such as multi-exposure, hyper lapse, a specific type of background music, etc., such that the highlight video compilations 208 have an appropriate look and feel for based upon the type of physical events that are recorded.

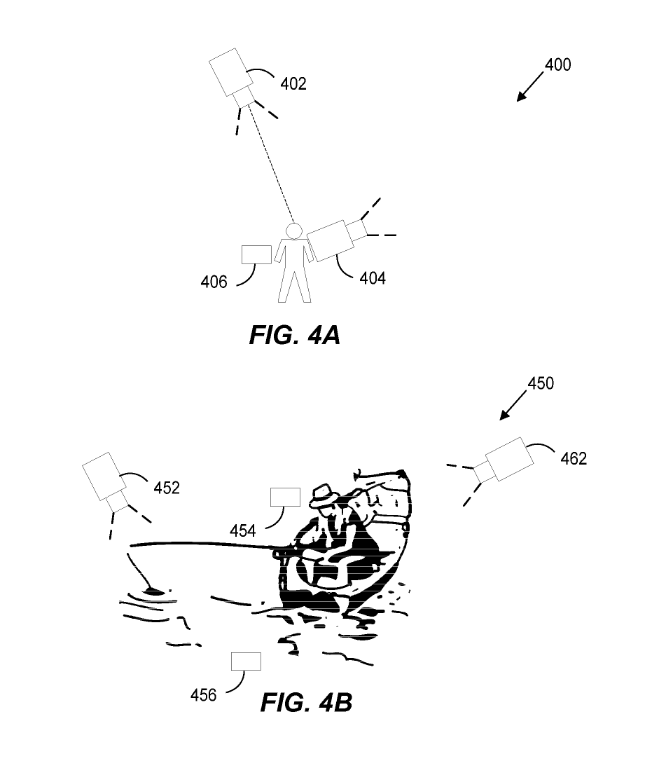

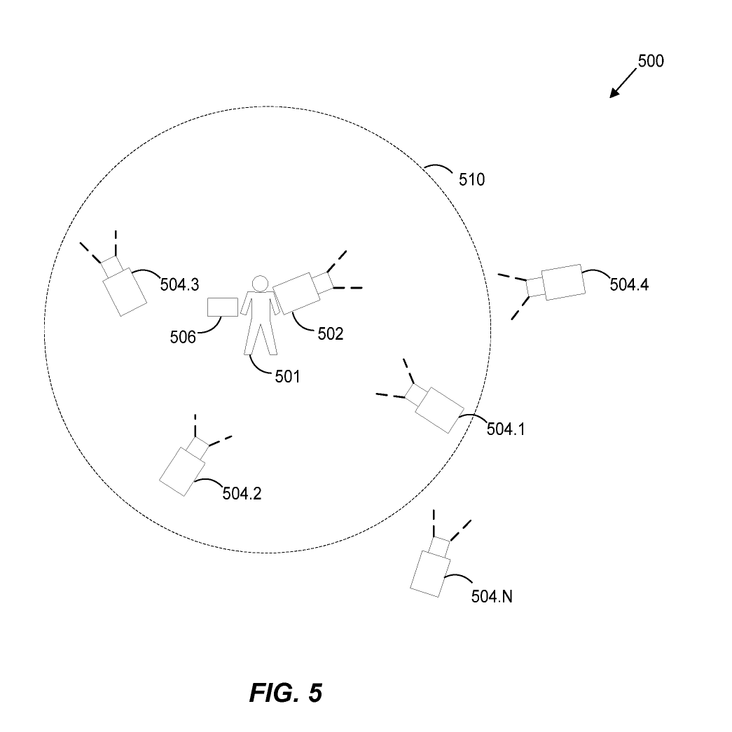

In the following embodiments discussed with reference to FIGS. 4A, 4B, and 5, multiple cameras may be configured to communicate with one another and/or with other devices using any suitable number of wired and/or wireless links. In addition, multiple cameras may be configured to communicate with one another and/or with other devices using any suitable number and type of communication networks and communication protocols. For example, in multiple camera embodiments, the multiple cameras may be implementations of recording device 102, as shown in FIG. 1. In embodiments, the other devices may be used and in the possession of other users.

As a result, the multiple cameras may be configured to communicate with one another via their respective communication units, such as communication unit 120, for example, as shown in FIG. 1. To provide another example, the multiple cameras may be configured to communicate with one another via a communication network, such as communication network 140, for example, as shown in FIG. 1. To provide yet another example, the multiple cameras may be configured to exchange data via communications with another device, such as computing device 160, for example, as shown in FIG. 1. In multiple camera embodiments, multiple cameras may share information with one another such as, for example, their current geographic location and/or sensor parameter values measured from their respective sensor arrays.

FIG. 4A is a schematic illustration example of a highlight video recording system 400 implementing camera tracking, according to an embodiment. Highlight video recording system 400 includes a camera 402, a camera 404, and a sensor 406. Camera 402 may be attached to or worn by a person and camera 404 may not be attached to the person (e.g., mounted to a windshield and facing the user). In various embodiments, sensor 406 may be an implementation of sensor array 122 and thus integrated as part of camera 404 or be an implementation of one or external sensors 126.1-126.N, as shown in FIG. 1.

As shown in FIG. 4A, a user may wear camera 404 to allow camera 404 to record video clips providing a point-of-view perspective of the user, while camera 402 may be pointed at the user to record video clips of the user. For instance, camera 404 may be mounted to a flying device that is positioned to record the user and his surrounding environment.

Sensor 406 may be worn by the user and may be configured to measure, store, and/or transmit one or more sensor parameter values to camera 402 and/or to camera 404. Upon receiving one or more sensor parameters from sensor 406 and/or from sensors integrated as part of camera 404 that exceed one or more respective threshold sensor parameter values or match a stored motion signature associated with a type of motion, camera 402 may add a data tag indicating occurrence of a physical event, initiate recording video, change a camera direction, and/or change a camera zoom level to record video of the user in greater detail. Additionally or alternatively, upon receiving one or more sensor parameters from sensor 406 and/or from sensors integrated as part of camera 404 that exceed one or more respective threshold sensor parameter values or match a stored motion signature associated with a type of motion, camera 404 may add a data tag indicating occurrence of a physical event, initiate recording video, change a camera direction, and/or change a camera zoom level to record video from the user's point-of-view in greater detail. For example, camera 404 attached to a flying device may fly close or approach the user, pull back or profile the user with a circular path.

Cameras 402 and/or 404 may optionally tag one or more recorded video frames upon receiving one or more sensor parameters that exceed one or more respective threshold sensor parameter values or match a stored motion signature associated with a type of motion, such that the highlight video compilations 208 may be subsequently generated.

Cameras 402 and 404 may be configured to maintain synchronized clocks, for example, via time signals received in accordance with one or more GNSS systems. Thus, as camera 402 and/or camera 404 tags one or more recorded video frames corresponding to when each respective physical event occurred, these physical event times may likewise be synchronized. This synchronization may help to facilitate the generation of highlight video compilations 208 from multiple cameras recording multiple tagged video clips by not requiring timestamp information from each of cameras 402 and 404. In other words, because tagged video clip frames may be tagged with sequential tag numbers, a time of an event recorded by camera 402 may be used to determine a time of other tagged frames having the same number.

To provide an illustrative example, camera 402 may initially record video of the user at a first zoom level. The user may then participate in an activity that causes sensor 406 to measure, generate, and transmit stored one or more sensor parameters from sensor 406 that are received by camera 402. Camera 402 may then change its zoom level to a second, higher zoom level, to capture the user's participation in the activity that caused the one or more sensor parameter values to exceed their respective threshold sensor parameter values or match a stored motion signature associated with a type of motion. Upon changing the zoom level, camera 402 may tag a frame of the recorded video clip with a data tag indicative of when the one or more sensor parameter values exceeded their respective threshold sensor parameter values or matched a stored motion signature associated with a type of motion.

To provide another illustrative example, camera 402 may initially not be pointing at the user but may do so upon receiving one or more sensor parameters from sensor 406 that exceed one or more respective threshold sensor parameter values or match a stored motion signature associated with a type of motion. This tracking may be implemented, for example, using a compass integrated as part of camera 402's sensor array 122 in conjunction with the geographic location of camera 404 that is worn by the user. Upon changing the direction of camera 404, camera 404 may tag a frame of the recorded video clip with a data tag indicative of when the one or more sensor parameter values exceeded their respective threshold sensor parameter values or matched a stored motion signature associated with a type of motion. Highlight video recording system 400 may facilitate any suitable number of cameras in this way, thereby providing for multiple video clips with tagged data frames for each occurrence of a physical event that resulted in one or more sensor parameters from any suitable number of sensors to exceed a respective threshold sensor parameter value or match a stored motion signature associated with a type of motion.

FIG. 4B is a schematic illustration example of a highlight video recording system 450 implementing multiple cameras having dedicated sensor inputs, according to an embodiment. Highlight video recording system 450 includes cameras 452 and 462, and sensors 454 and 456. In various embodiments, sensors 454 and 456 may be an implementation of sensor array 122 for each of cameras 452 and 462, respectively, or one or more external sensors 126.1-126.N, as shown in FIG. 1.

In an embodiment, camera 452 may tag one or more data frames based upon one or more sensor parameter values received from sensor 454, while camera 462 may tag one or more data frames based upon one or more sensor parameter values received from sensor 456. As a result, each of cameras 452 and 462 may be associated with dedicated sensors, respectively sensors 454 and 456, such that the types of physical events they record are also associated with the sensor parameter values measured by each dedicated sensor.

In an embodiment, upon receiving one or more sensor parameter values from sensor 454 that exceed one or more respective threshold sensor parameter values or match a stored motion signature associated with a type of motion, camera 452 may add a data tag indicating occurrence of a physical event, initiate recording a video clip, change a camera zoom level, etc., to record video in the direction of camera 452. Camera 452 may be positioned and directed in a fixed manner, such that a specific type of physical event may be recorded. For example, sensor 454 may be integrated as part of a fish-finding device, and camera 452 may be positioned to record physical events within a certain region underwater or on top of the water. Continuing this example, when camera 452 receives one or more sensor parameter values from the fish-finding device that may correspond to a fish being detected, then camera 452 may record a video clip of the fish being caught and hauled into the boat.

Similarly, upon receiving one or more sensor parameter values from sensor 456 that exceed one or more respective threshold sensor parameter values or match a stored motion signature associated with a type of motion, camera 462 may add a data tag indicating occurrence of a physical event, initiate recording a video clip, changing a camera zoom level, etc., to record video in the direction of camera 462. Camera 462 may also be positioned and directed in a fixed manner, such that a specific type of physical event may be recorded. For example, sensor 456 may be integrated as part of a device worn by the fisherman as shown in FIG. 4B, and camera 462 may be positioned to record the fisherman. Continuing this example, when camera 462 receives one or more sensor parameter values from the device worn by the fisherman indicating that the fisherman may be expressing increased excitement (e.g., a heart-rate monitor, perspiration monitor, etc.), then camera 462 may record a video clip of the fisherman's reaction as the fish is being caught and hauled into the boat.

Cameras 452 and/or 462 may optionally tag one or more recorded video frames upon recording video clips and/or changing zoom levels, such that the highlight video compilations may be subsequently manually or automatically generated.

FIG. 5 is a schematic illustration example of a highlight video recording system 500 implementing multiple camera locations to capture highlight videos from multiple vantage points, according to an embodiment. Highlight video recording system 500 includes N number of cameras 504.1-504.N, a user camera 502, and a sensor 506, which may be worn by user 501.

In some embodiments, such as those discussed with reference to FIG. 4B, for example, multiple cameras 452, 462 may record video clips from different vantage points and tag the video clips or perform other actions based upon one or more sensor parameter values received from dedicated sensors 454, 456. However, in other embodiments, such as those discussed with reference to FIG. 5, multiple cameras may record video clips from different vantage points and tag the video clips or perform other actions based upon one or more sensor parameter values received from any suitable number of different sensors or the same sensor.

For example, as shown in FIG. 5, a user may wear sensor 506, which may be integrated as part of camera 502 or as a separate sensor. In embodiments in which sensor 506 is not integrated as part of camera 502, cameras 504.1-504.N may be configured to associate user 501 with sensor 506 and camera 502. For example, cameras 504.1-504.N may be preconfigured, programmed, or otherwise configured to correlate sensor parameter values received from sensor 506 with camera 502. In this way, although only a single user 501 is shown in FIG. 5 for purposes of brevity, embodiments of highlight video recording system 500 may include generating highlight video compilations 208 of any suitable number of users having respective cameras and sensors (which may be integrated or external sensors). The highlight video compilation 208 generated from the video clips may depict one user at time or multiple users by automatically identifying the moments when two or more users are recorded together.

In an embodiment, each of cameras 504.1-504.N may be configured to receive one or more sensor parameter values from any suitable number of users' respective sensor devices. For example, user 501 may be a runner in a race with a large number of participants. For purposes of brevity, the following example is provided using only a single sensor 506. Each of cameras 504.1-504.N may be configured to tag a video frame of their respectively recorded video clips upon receiving one or more sensor parameter values from sensor 506 that exceed a threshold sensor parameter value or match a stored motion signature associated with a type of motion.

Each of cameras 504.1-504.N may transmit their respectively recorded video clips having one or more tagged data frames to an external computing device, such as computing device 160, for example, as shown in FIG. 1. Again, each of cameras 504.1-504.N may tag their recorded video clips with data such as a sequential tag number, their geographic location, a direction, etc. The direction of each of cameras 504.1-504.N may be, for example, added to the video clips as tagged data in the form of one or more sensor parameter values from a compass that is part of each camera's respective integrated sensor array 122.

In some embodiments, the recorded video clips may be further analyzed to determine the video clips (or portions of video clips) to select in addition to or as an alternative to the tagged data frames.

For example, motion flow of objects in one or more video clips may be analyzed as a post-processing operation to determine motion associated with one or more cameras 504.1-504.N. Using any suitable image recognition techniques, this motion flow may be used to determine the degree of motion of one or more cameras 504.1-504.N, whether each camera is moving relative to one another, the relative speed of objects in one or more video clips etc. If a motion flow analysis indicates that certain other cameras or objects recorded by other cameras exceeds a suitable threshold sensor parameter value or matches a stored motion signature associated with a type of motion, then portions of those video clips may be selected for generation of a highlight video compilation 208.

To provide another example, objects may be recognized within the one or more video clips. Upon recognition of one or more objects matching a specific image recognition profile, further analysis may be applied to determine an estimated distance between objects and/or cameras based upon common objects recorded by one or more cameras 504.1-504.N. If an object analysis indicates that certain objects are within a threshold distance of one another, then portions of those video clips may be selected for generation of a highlight video compilation.

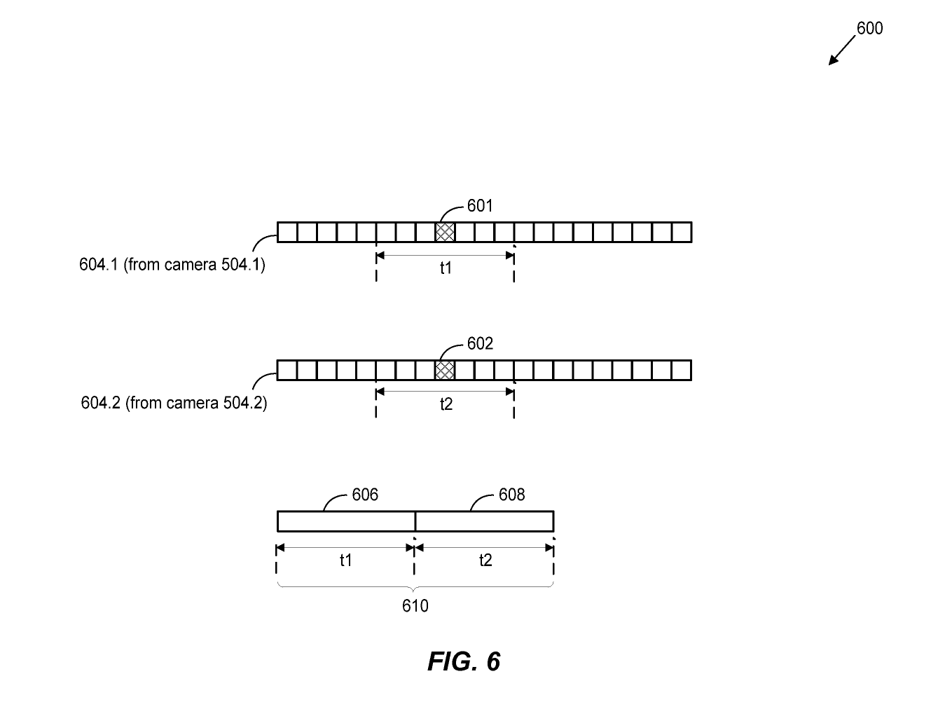

The external computing device may then further analyze the tagged data in the one or more of recorded video clips from each of cameras 504.1-504.N to automatically generate (or allow a user to manually generate) a highlight video compilation 208, which is further discussed below with reference to FIG. 6.

FIG. 6 is a block diagram of an exemplary highlight video compilation system 600 using the recorded video clips from each of cameras 504.1-504.N, according to an embodiment.

In an embodiment, highlight video compilation system 600 may sort the recorded video clips from each of cameras 504.1-504.N to determine which recorded video clips to use to generate a highlight video compilation. For example, FIG. 5 illustrates a geofence 510. Geofence 510 may be represented as a range of latitude and longitude coordinates associated with a specific geographic region. For example, if user 501 is participating in a race, then geofence 510 may correspond to a specific mile marker region in the race, such as the last mile, a halfway point, etc. Geofence 510 may also be associated with a certain range relative to camera 502 (and thus user 501). As shown in FIG. 5, user 501 is located within the region of interest defined by geofence 510.

In an embodiment, highlight video compilation system 600 may eliminate some video clips by determining which of the respective cameras 504.1-504.N were located outside of geofence 510 when their respective video clips were tagged. In other words, each of cameras 504.1-504.N within range of sensor 506 may generate data tagged video clips upon receiving one or more sensor parameter values from sensor 506 that exceed a threshold sensor parameter value or match a stored motion signature associated with a type of motion. But some of cameras 504.1-504.N may not have been directed at user 501 while recording and/or may have been too far away from user 501 to be considered high enough quality for a highlight video compilation.

Therefore, in an embodiment, highlight video compilation system 600 may eliminate recorded video clips corresponding to cameras 504.1-504.N that do not satisfy both conditions of being located inside of geofence 510 and being directed towards the geographic location of camera 502. To provide an illustrative example, highlight video compilation 600 may apply rules as summarized below in Table 1.

TABLE 1

| Camera | Within geofence 510? | Directed towards camera 502? |
|---|---|---|
| 504.1 | Yes | Yes |
| 504.2 | Yes | Yes |
| 504.3 | Yes | No |
| 504.4 | No | N/A |
| 504.5 | No | N/A |

As shown in Table 1, only cameras 504.1 and 504.2 satisfy both conditions of this rule. Therefore, highlight video compilation system 600 may select only video clips from each of cameras 504.1 and 504.2 to generate a highlight video compilation. As shown in FIG. 6, video clips 604.1 and 604.2 have been recorded by and received from each of cameras 504.1 and 504.2, respectively. Video clip 604.1 includes a tagged frame 601 at a time corresponding to when camera 504.1 received the one or more sensor parameter values from sensor 506 exceeding one or more respective threshold sensor parameter values or matching a stored motion signature associated with a type of motion. Similarly, video clip 604.2 includes a tagged frame 602 at a time corresponding to when camera 504.2 received the one or more sensor parameter values from sensor 506 exceeding one or more respective threshold sensor parameter values or matching a stored motion signature associated with a type of motion.

In an embodiment, highlight video compilation system 600 may extract video clips 606 and 608 from each of video clips 604.1 and 604.2, respectively, each having a respective video time window t1 and t2. Again, t1 and t2 may represent the overall playing time of video clips 606 and 608, respectively. Highlight video compilation 610, therefore, has an overall length of t1+t2. As previously discussed with reference to FIGS. 3A-3B, highlight video compilation system 600 may allow a user to set default values and/or modify settings to control the values of t1 and/or t2 as well as whether the position of frames 601 and/or 602 are centered within each of their respective video clips 606 and 608.

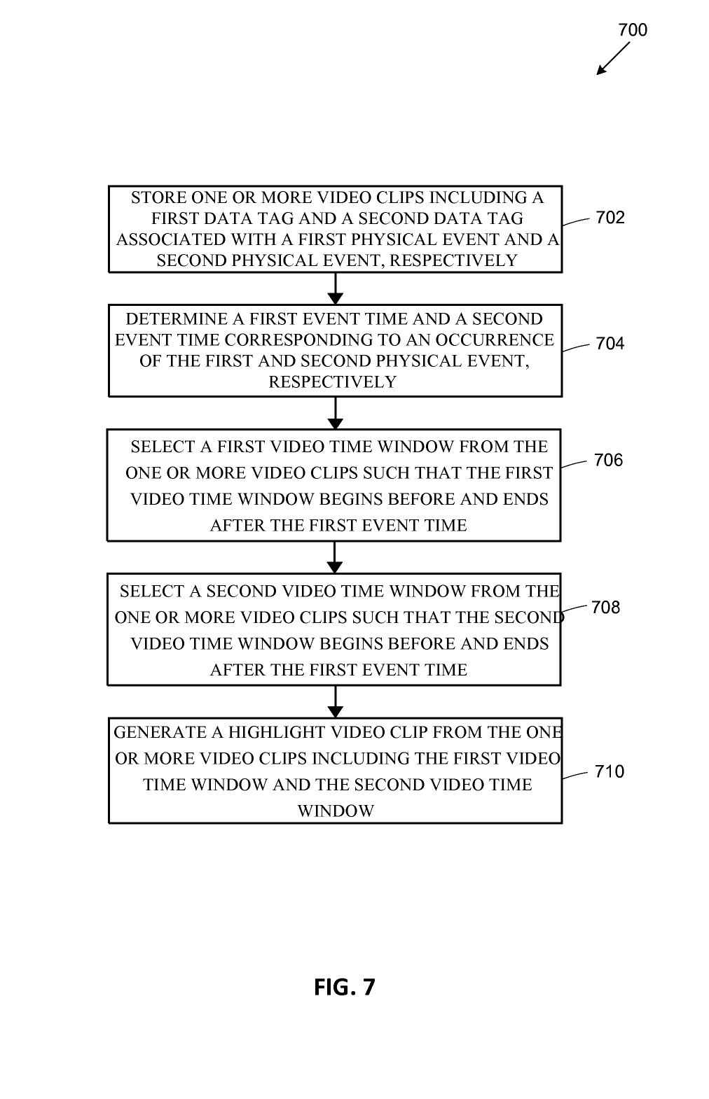

FIG. 7 illustrates a method flow 700, according to an embodiment. In an embodiment, one or more portions of method 700 (or the entire method 700) may be implemented by any suitable device, and one or more portions of method 700 may be performed by more than one suitable device in combination with one another. For example, one or more portions of method 700 may be performed by recording device 102, as shown in FIG. 1. To provide another example, one or more portions of method 700 may be performed by computing device 160, as shown in FIG. 1.

For example, method 700 may be performed by any suitable combination of one or more processors, applications, algorithms, and/or routines, such as CPU 104 and/or GPU 106 executing instructions stored in highlight application module 114 in conjunction with user input received via user interface 108, for example. To provide another example, method 700 may be performed by any suitable combination of one or more processors, applications, algorithms, and/or routines, such as CPU 162 and/or GPU 164 executing instructions stored in highlight application module 172 in conjunction with user input received via user interface 166, for example.

Method 700 may start when one or more processors store one or more video clips including a first data tag and a second data tag associated with a first physical event and a second physical event, respectively (block 702). The first physical event may, for example, result in a first sensor parameter value exceeding a threshold sensor parameter value or matching a stored motion signature associated with a type of motion. The second physical event may, for example, result a second sensor parameter value exceeding the threshold sensor parameter value or matching a stored motion signature associated with a type of motion (block 702).

The first and second parameter values may be generated, for example, by a person wearing one or more sensors while performing the first and/or second physical events. The data tags may include, for example, any suitable type of identifier such as a timestamp, a sequential data tag number, a geographic location, the current time, etc. (block 702).

The one or more processors storing the one or more video clips may include, for example, one or more portions of recording device 102, such as CPU 104 storing the one or more video clips in a suitable portion of memory unit 112, for example, as shown in FIG. 1 (block 702).

The one or more processors storing the one or more video clips may alternatively or additionally include, for example, one or more portions of computing device 160, such as CPU 162 storing the one or more video clips in a suitable portion of memory unit 168, for example, as shown in FIG. 1 (block 702).

Method 700 may include one or more processors determining a first event time associated with when the first sensor parameter value exceeded the threshold sensor parameter value or matched a stored motion signature associated with a type of motion and a second event time associated with when the second sensor parameter value exceeded the threshold sensor parameter value or matched a stored motion signature associated with a type of motion (block 704). These first and second event times may include, for example, a time corresponding to a tagged frame within the one or more stored video clips, such as tagged frames 202.1-202.N, for example, as shown and discussed with reference to FIG. 2 (block 704).

Method 700 may include one or more processors selecting a first video time window from the one or more first video clips such that the first video time window begins before and ends after the first event time (block 706). In an embodiment, method 700 may include the selection of the first video time window from the one or more video clips in an automatic manner not requiring user intervention (block 706). This first video time window may include, for example, a time window t1 corresponding to the length of video clip 206.1, for example, as shown and discussed with reference to FIG. 2 (block 706).

Method 700 may include one or more processors selecting a second video time window from the one or more first video clips such that the second video time window begins before and ends after the second event time (block 708). In an embodiment, method 700 may include the selection of the second video time window from the one or more video clips in an automatic manner not requiring user intervention (block 708). This second video time window may include, for example, a time window t2 or t3 corresponding to the length of video clips 206.2 and 206.3, respectively, for example, as shown and discussed with reference to FIG. 2 (block 708).

Method 700 may include one or more processors generating a highlight video clip from the one or more video clips, the highlight video clip including the first video time window and the second video time window (block 710). This highlight video clip may include for example, highlight video compilation 208, as shown and discussed with reference to FIG. 2 (block 710).

Although the foregoing text sets forth a detailed description of numerous different embodiments, it should be understood that the detailed description is to be construed as exemplary only and does not describe every possible embodiment because describing every possible embodiment would be impractical, if not impossible. In light of the foregoing text, numerous alternative embodiments may be implemented, using either current technology or technology developed after the filing date of this patent application.

What is claimed is:

1. A device configured to generate a highlight video clip, the device comprising:
a memory unit configured to store one or more video clips, the one or more video clips, in combination, including a first data tag and a second data tag associated with a first physical event occurring in the one or more video clips and a second physical event occurring in the one or more video clips, respectively; and
a processor configured to
(i) determine a first event time and a second event time based on a first sensor parameter value generated by a first sensor, and
(ii) generate a highlight video clip of the first physical event and the second physical event by selecting a first video time window and a second video time window from the one or more video clips such that the first video time window begins before and ends after the first event time and the second video time window begins before and ends after the second event time.

2. The device of claim 1, wherein the second physical event occurs shortly after the first physical event and the second video time window from the one or more video clips begins immediately after the first video time window ends such that the highlight video clip includes the first physical event and the second physical event without interruption.

3. The device of claim 1, wherein the first sensor is integrated within the device.

4. The device of claim 1, wherein the processor is further configured to determine the first event time and the second event time based on the first sensor parameter value and a second sensor parameter value generated by a second sensor.

5. The device of claim 4, further comprising a communication unit configured to receive a second sensor parameter value from the second sensor, the second sensor being external to the device.

6. The device of claim 1, further comprising:
a communication unit configured to send the highlight video clip to an external computing device, and
a camera configured to record the one or more video clips.

7. The device of claim 1, wherein the memory unit is further configured to store a motion signature and the processor is further configured to compare a plurality of first sensor parameter values to the stored motion signature to determine at least one of the first event time and the second event time.

8. The device of claim 1, wherein the first and the second event times are substantially centered within the first and second video time windows, respectively.

9. A system configured to generate a highlight video clip, the system comprising:
a first device including a first camera configured to record one or more first video clips;
a first sensor, integrated within the first device, configured to measure a first sensor parameter value associated with first and second physical events occurring while the one or more first video clips are being recorded;
a processor configured to:
(i) determine a first event time and second event time based on the first sensor parameter value, and
(ii) generate a first data tag indicating the first event time and a second data tag indicating the second event time; and
a memory unit configured to store the one or more first video clips including the first and second data tags;
wherein the processor is further configured to:
(iii) generate a highlight video clip of the first physical event and the second physical event by selecting a first video time window and a second video time window from the one or more first video clips such that the first video time window begins before and ends after the first event time and the second video time window begins before and ends after the second event time.

10. The system of claim 9, wherein the second physical event occurs shortly after the first physical event and the second video time window from the one or more first video clips begins immediately after the first video time window ends such that the highlight video clip includes the first physical event and the second physical event without interruption.

11. The system of claim 9, further comprising a communication unit configured to send the highlight video clip to an external computing device.

12. The system of claim 9, wherein the memory unit is further configured to store a motion signature and the processor is further configured to compare a plurality of first sensor parameter values to the stored motion signature to determine at least one of the first event time and the second event time.

13. The system of claim 9, further comprising a second device including a second camera configured to record one or more second video clips.

14. The system of claim 9, further comprising:
a second sensor, external to the first device, configured to measure a second sensor parameter value; and
a second device including a second camera configured to record one or more second video clips;
wherein the second sensor parameter value is associated with a third physical event occurring while the second video is being recorded;
wherein the second device is further configured to:
(i) determine a third event time based on the second sensor parameter value, and
(ii) select a third video time window from the one or more second video clips such that the generated highlight video clip includes first video clips and second video clips.

15. A computer-implement method, comprising:
storing, by a memory unit, one or more video clips including a first data tag and a second data tag associated with a first physical event and a second physical event, respectively;
determining, by one or more processors, a first event time and a second event time based on a first sensor parameter value generated by a first sensor;
selecting, by one or more processors, a first video time window and a second video time window from the one or more video clips such that the first video time window begins before and ends after the first event time and the second video time window begins before and ends after the second event time; and
generating, by one or more processors, a highlight video clip from the one or more video clips, the highlight video clip of the first physical event and the second physical event including the first video time window and the second video time window.

16. The computer-implement method of claim 15, wherein the second physical event occurs shortly after the first physical event and the second video time window from the one or more video clips begins immediately after the first video time window ends such that the highlight video clip includes the first physical event and the second physical event without interruption.

17. The computer-implement method of claim 15, wherein the memory unit is further configured to store a motion signature and the processor is further configured to compare a plurality of first sensor parameter values to the stored motion signature to determine at least one of the first event time and the second event time.

18. The computer-implement method of claim 15, further comprising receiving, by a communication unit, the first video clips from a camera configured to record the one or more first video clips.

19. The computer-implement method of claim 15, further comprising:
tracking, by a location determining component, a location of the device during the act of storing the one or more first video clips, and
wherein the selecting the first video time window and the second video time window from the one or more video clips comprises determining, by one or more processors, the first video time window and the second video time window corresponding to when the location of the device was within a geofenced perimeter.

20. The computer-implement method of claim 15, wherein selecting the first and the second video time windows comprises selecting, by one or more processors, the first and second video time windows from the one or more video clips such that the first event time is substantially centered within the first video time window, and the second event time is substantially centered within the second time window.
